(19) United States
(12) Patent Application Publication
(10) Pub. No.: US 2015/0321139 A1
(43) Pub. Date: Nov. 12, 2015

(54) PROCESS FOR ABSORPTION OF CO2 FROM A GAS MIXTURE USING AN AQUEOUS SOLUTION OF A DIAMINE

(71) Applicants: Alexander SCHRAVEN, Issum (DE); Jochen NIEMEYER, Münster (DE); Manfred NEUMANN, Marl (DE); Stefanie RINKER, Hünxe (DE); Rolf SCHNEIDER, Gründau-Rothenbergen (DE); Jörn ROLKER, Alzenau (DE)

(72) Inventors: Alexander Schraven, Issum (DE); Jochen Niemeyer, Essen (DE); Manfred Neumann, Marl (DE); Stefanie Rinker, Dorsten (DE); Rolf Schneider, Gründau-Rothenbergen (DE); Jörn Rolker, Alzenau (DE)

(21) Appl. No.: 14/649,068

(22) PCT Filed: Nov. 13, 2013
(86) PCT No.: PCT/EP2013/073670

§ 371 Date: Jun. 2, 2015

(30) Foreign Application Priority Data
Dec. 4, 2012 (DE) 10 2012 222 157.3

(51) Int. Cl. B01D 53/14

(52) U.S. Cl. CPC B01D 53/1493; B01D 53/1425; B01D 53/1475; B01D 2252/2041

(57) ABSTRACT

CO₂ is absorbed from a gas mixture by bringing the gas mixture into contact with an absorption medium comprising water and at least one amine of formula (I)

R¹R²NCH₂CH₂CHR⁴NHR³, (I)

where R¹, R² and R³ are, independently of one another, C₁-C₃-alkyl radicals, R⁴ is hydrogen, methyl or ethyl and the radicals R¹, R², R³ and R⁴ together comprise not more than 5 carbon atoms.

The invention relates to a method of absorbing CO₂ from a gas mixture.

Gas streams which have an undesirably high content of CO₂ which has to be reduced for further processing, for transport or for avoiding CO₂ emissions occur in numerous industrial and chemical processes.

On the industrial scale, CO₂ is typically absorbed from a gas mixture by using aqueous solutions of alkanolamines as absorption medium. The loaded absorption medium is regenerated by heating, depressurization to a lower pressure or stripping, and the carbon dioxide is desorbed. After the regeneration process, the absorption medium can be used again. These methods are described, for example, in Rolker, J.; Arlt, W.; “Abtrennung von Kohlendioxid aus Rauchgasen mittels Absorption” in Chemie Ingenieur Technik 2006, 78, pages 416 to 424 and also in Kohl, A. L.; Nielsen, R. B., “Gas Purification”, 5^{th} Edition, Gulf Publishing, Houston 1997.

However, these methods have the disadvantage that the removal of CO₂ by absorption and subsequent desorption requires a relatively large amount of energy and that the mass-based CO₂ capacity of the absorption medium is low.

Diamines, oligoamines and polyamines have been proposed as alternatives to alkanolamines in the prior art.

WO 2004/082809 describes absorption of CO₂ from gas streams using concentrated aqueous solutions of diamines of the formula (R¹)₂N(CR²R³)ₙN(R¹)₂, where R¹ can be a C₁-C₄-alkyl radical and R², R³ can each be, independently of one another, hydrogen or a C₁-C₄-alkyl radical. In the case of n=3, the diamines N,N,N′,N′-tetramethyl-1,3-propanediamine and N,N,N′,N′-tetraethyl-1,3-propanediamine are explicitly disclosed. The diamines having two tertiary amino groups have the disadvantage that the absorption of CO₂ proceeds only slowly.

JP 2005-296897 describes absorption of CO₂ or H₂S using an absorption medium which contains an alkanolamine or an amino acid in combination with a diamine or triamine The combination of 2-ethylaminoethanol with N,N′-dimethyl-1,3-propanediamine is explicitly disclosed.

WO 2010/012883 describes absorption of CO₂ from gas streams using an aqueous solution of N,N,N′,N′-tetramethyl-1,6-hexanediamine. In order to avoid phase separation into two liquid phases during the absorption, a primary or secondary amine has to be additionally added to the absorption medium.

WO 2011/009195 describes absorption of CO₂ or H₂S using an aqueous solution of a polyamine which preferably contains a secondary amino group. The diamines 1,3-propanediamine, N,N′-dimethyl-1,3-propanediamine and N,N′-diisopropyl-1,3-propanediamine are explicitly disclosed amongst others.

WO 2011/080405 describes absorption of CO₂ from gas streams using aqueous solutions of diamines of the formula R¹R²N(CR⁴R⁵)(CR⁶R⁷)ₐNHR³, where R¹, R² can each be, independently of one another, a C₁-C₁₂-alkyl radical or a C₁-C₁₂-alkoxyalkyl radical, R³ to R⁷ can each be, independently of one another, hydrogen, a C₁-C₁₂-alkyl radical or a C₁-C₁₂-alkoxyalkyl radical, a=1 to 11 and R³ is different from R¹ and R². In the case of a=2, the diamines [N,N-dimethyl-N′-(2-butyl)]-1,3-propanediamine, [N,N-dimethyl-N′-butyl]-1,3-propanediamine, [N,N-dimethyl-N′-(methyl-2-propyl)]-1,3-propanediamine and [N,N-dimethyl-N′-tert-butyl]-1,3-propanediamine are explicitly disclosed.

WO 2012/007084 describes absorption of CO₂ from gas streams using aqueous solutions of N-isopropyl-1,3-propanediamine These solutions can contain tertiary amines or alkyldiamines in addition to N-isopropyl-1,3-propanediamine, with N,N,N′,N′-tetramethyl-1,3-propanediamine and N,N,N′,N′-tetraethyl-1,3-propanediamine being mentioned, inter alia, as tertiary amines and 2,2,N,N-tetramethyl-1,3-propanediamine and N,N′-dimethyl-1,3-propanediamine being mentioned, inter alia, as alkyldiamines.

However, the diamines known from the prior art generally have an unsatisfactory capacity or an unsatisfactory rate of absorption in the absorption of CO₂. In addition, phase separation of the absorption medium into two liquid phases frequently occurs at elevated temperatures and this can lead to malfunctions during operation of absorber and desorber.

It has now been found that both a high weight-based capacity and a satisfactory rate of absorption can be achieved and phase separation into two liquid phases in the desorber can be avoided in the absorption of CO₂ when using an absorption medium containing water and a N,N,N′-trialkyl-1,3-propanediamine having not more than 8 carbon atoms.

The invention accordingly provides a method of absorbing CO₂ from a gas mixture by bringing the gas mixture into contact with an absorption medium comprising water and at least one amine of formula (I)

R¹R²NCH₂CH₂CHR⁴NHR³, (I)

where R¹, R² and R³ are, independently of one another, C₁-C₃-alkyl radicals, R⁴ is hydrogen, methyl or ethyl and the radicals R¹, R², R³ and R⁴ together comprise not more than 5 carbon atoms.

The amines of formula (I) used in the process of the invention are diamines which have a secondary amino group and a tertiary amino group and in which the nitrogen atoms are separated from one another by a chain of three carbon atoms. The diamines have a total of not more than 8 carbon atoms, i.e. the radicals R¹, R², R³ and R⁴ in formula (I) together comprise not more than 5 carbon atoms.

The carbon atom of the chain which is adjacent to the secondary amino group can be substituted by a methyl group or an ethyl group but is preferably unsubstituted, i.e. R⁴ in formula (I) can be hydrogen, methyl or ethyl, with R⁴ preferably being hydrogen.

The tertiary amino group is preferably substituted by methyl groups or ethyl groups, i.e. R¹ and R² in formula (I) are each, independently of one another, methyl or ethyl. The tertiary amino group is particularly preferably substituted by two methyl groups, i.e. R¹ and R² in formula (I) are each methyl. Greatest preference is given to the tertiary amino group being substituted by two methyl groups and the secondary amino group being substituted by an n-propyl group or an isopropyl group, i.e. in formula (I), R¹ and R² are each methyl and R³ is n-propyl or isopropyl, with isopropyl being preferred.

Suitable amines of formula (I) are N1,N1,N3-trimethyl-1,3-propanediamine, N3-ethyl-N1,N1-dimethyl-1,3-propanediamine, N1,N1-dimethyl-N3-propyl-1,3-propanediamine, N1,N1-dimethyl-N3-(1-methylethyl)-1,3-propanediamine, N1-ethyl-N1,N3-dimethyl-1,3-propanediamine, N1,N3-diethyl-N1-methyl-1,3-propanediamine, N1,N1-diethyl-N3-methyl-1,3-propanediamine, N1,N3-dimethyl-N1-propyl-1,3-propanediamine, N1,N3-dimethyl-N1-(1-methylethyl)-1,3-propanediamine, N1,N1,N3-trimethyl-1,3-butanediamine, N3-ethyl-N1,N1-dimethyl-1,3-butanediamine, N1-ethyl-N1,N3-dimethyl-1,3-butanediamine and N1,N1,N3-trimethyl-1,3-pentanediamine Preference is given to N1,N1,N3-trimethyl-1,3-propanediamine, N3-ethyl-N1,N1-dimethyl-1,3-propanediamine, N1,N1-dimethyl-N3-propyl-1,3-propanediamine, N1,N1-dimethyl-N3-(1-methylethyl)-1,3-propanediamine, N1-ethyl-N 1,N3-dimethyl-1,3-propanediamine, N1,N3-diethyl-N1-methyl-1,3-propanediamine, N1,N1-diethyl-N3-methyl-1,3-propanediamine, N1,N3-dimethyl-N1-propyl-1,3-propanediamine and N1,N3-dimethyl-N1-(1-methylethyl)-1,3-propanediamine Further preference is given to N1,N1,N3-trimethyl-1,3-propanediamine, N3-ethyl-N 1,N1-dimethyl-1,3-propane-diamine, N1,N1-dimethyl-N3-propyl-1,3-propanediamine, N1,N1-dimethyl-N3-(1-methylethyl)-1,3-propanediamine, N1-ethyl-N1,N3-dimethyl-1,3-propanediamine, N1,N3-diethyl-N1-methyl-1,3-propanediamine and N1,N1-diethyl-N3-methyl-1,3-propanediamine. Even further preference is given to N1,N1,N3-trimethyl-1,3-propanediamine, N3-ethyl-N1,N1-dimethyl-1,3-propanediamine, N1,N1-dimethyl-N3-propyl-1,3-propanediamine and N1,N1-dimethyl-N3-(1-methylethyl)-1,3-propanediamine. Greatest preference is given to N1,N1-dimethyl-N3-propyl-1,3-propanediamine and N1,N1-dimethyl-N3-(1-methylethyl)-1,3-propanediamine, in particular N1,N1-dimethyl-N3-(1-methylethyl)-1,3-propanediamine.

Amines of formula (I) can be prepared by known processes. A generally applicable synthetic route for preparing amines of formula (I) is addition of a secondary amine R¹R²NH to the CC-double bond of acrolein, methyl vinyl ketone or ethyl vinyl ketone and subsequent reductive aminiation of the addition product with a primary amine R³NH₂ and hydrogen Amines of formula (I) where R⁴=H can be prepared by addition of a secondary amine R¹R²NH to the CC-double bond of acrylonitrile, subsequent reduction of the nitrile to the primary amine and subsequent reductive aminiation of the primary amino group with formaldehyde, acetaldehyde, propionaldehyde or acetone. As an alternative, amines of formula (I) where R⁴=H can also be obtained by addition of a secondary amine R¹R²NH to the CC-double bond of an acrylamide whose nitrogen atom is substituted by the radical R³ and hydrogenation of the resulting addition product.

The working medium used in the process of the invention comprises water and at least one amine of formula (I). The content of amines of formula (I) in the absorption medium is preferably from 10 to 60% by weight, particularly preferably from 20 to 50% by weight. The content of water in the absorption medium is preferably from 40 to 80% by weight.

The absorption medium may contain at least one sterically unhindered primary or secondary amine as activator in addition to water and amines of formula (I), with amines of formula (I) not being used as activator. For the purposes of the invention, a sterically unhindered primary amine is a primary amine in which the amino group is bound to a carbon atom to which at least one hydrogen atom is bound. For the purposes of the invention, a sterically unhindered secondary amine is a secondary amine in which the amino group is bound to carbon atoms to which at least two hydrogen atoms are bound in each case. The content of sterically unhindered primary or secondary amines is preferably from 0.1 to 10% by weight, particularly preferably from 0.5 to 8% by weight. Suitable activators are activators known from the prior art, for example ethanolamine, piperazine and 3-(methylamino)propylamine. The addition of an activator leads to acceleration of the absorption of CO₂ from the gas mixture without absorption capacity being lost.

The absorption medium may contain one or more physical solvents in addition to water and amines The fraction of physical solvents can in this case be up to 50% by weight. Suitable physical solvents are sulpholane, aliphatic acid amides, such as N-formylmorpholine, N-acetylmorpholine, N-alkylpyrrolidones, in particular N-methyl-2-pyrrolidone, or N-alkylpiperidones, and also diethylene glycol, triethylene glycol and polyethylene glycols and their alkyl ethers, in particular diethylene glycol monobutyl ether. However, the absorption medium preferably does not contain any physical solvents.

The absorption medium may additionally comprise additives such as corrosion inhibitors, wetting-promoting additives and defoamers.

All compounds known to the skilled person as suitable corrosion inhibitors for the absorption of CO₂ using alkanolamines can be used as corrosion inhibitors in the absorption medium, in particular the corrosion inhibitors described in U.S. Pat. No. 4,714,597.

The cationic surfactants, zwitterionic surfactants and nonionic surfactants known from WO 2010/089257 page 11, line 18 to page 13, line 7 are preferably used as wetting-promoting additive.

All compounds known to the skilled person as suitable defoamers for the absorption of CO₂ using alkanolamines can be used as defoamers in the absorption medium.

In the method of the invention, the gas mixture may be a natural gas, a methane-containing biogas from a fermentation, composting or a sewage treatment plant, a combustion off-gas, an off-gas from a calcination reaction, such as the burning of lime or the production of cement, a residual gas from a blast-furnace operation for producing iron or a gas mixture resulting from a chemical reaction, such as, for example, a synthesis gas containing carbon monoxide and hydrogen, or a reaction gas from a steam-reforming hydrogen production process. The gas mixture is preferably a combustion off-gas, a natural gas or a biogas, with particular preference being given to a combustion off-gas, for example from a power station.

The gas mixture can contain further acid gases, for example COS, H₂S, CH₃SH or SO₂, in addition to CO₂. In a preferred embodiment, the gas mixture contains H₂S in addition to CO₂. A combustion off-gas is preferably desulphurized beforehand, i.e. SO₂ is removed from the gas mixture by a desulphurization method known from the prior art, preferably by a gas scrub using milk of lime, before the method of the invention is carried out.

Before being brought into contact with the absorption medium, the gas mixture preferably has a CO₂ content in the range from 0.1 to 50% by volume, particularly preferably in the range from 1 to 20% by volume and most preferably in the range from 10 to 20% by volume.

The gas mixture may contain oxygen in addition to CO₂, preferably in a proportion of from 0.1 to 25% by volume, and particularly preferably in a proportion of from 0.1 to 10% by volume.

For the method of the invention, all apparatus suitable for contacting a gas phase with a liquid phase can be used to contact the gas mixture with the absorption medium. Preferably, absorption columns or gas scrubbers known from the prior art are used, for example membrane contactors, radial flow scrubbers, jet scrubbers, venturi scrubbers, rotary spray scrubbers, random packing columns, ordered packing columns or tray columns. With particular preference, absorption columns are used in countercurrent flow mode.

In the method of the invention, the absorption of CO₂ is carried out preferably at a temperature of the absorption medium in the range from 0 to 80° C., more preferably 20 to 60° C. When using an absorption column in countercurrent flow mode, the temperature of the absorption medium is more preferably 30 to 60° C. on entry into the column, and 35 to 80° C. on exit from the column.

The CO₂-containing gas mixture is preferably brought into contact with the absorption medium at an initial partial pressure of CO₂ of from 0.01 to 4 bar. The initial partial pressure of CO₂ in the gas mixture is particularly preferably from 0.05 to 3 bar. The total pressure of the gas mixture is preferably in the range from 0.8 to 50 bar, particularly preferably from 0.9 to 30 bar.

In a preferred embodiment of the method of the invention, CO₂ absorbed in the absorption medium is desorbed again by increasing the temperature and/or reducing the pressure and the absorption medium after this desorption of CO₂ is used again for the absorption of CO₂. The desorption is preferably carried out by increasing the temperature. By such cyclic operation of absorption and desorption, CO₂ can be entirely or partially separated from the gas mixture and obtained separately from other components of the gas mixture.

As an alternative to the increase in temperature or the reduction in pressure, or in addition to an increase in temperature and/or a reduction in pressure, it is also possible to carry out a desorption by stripping the absorption medium loaded with CO₂ by means of an inert gas, for example nitrogen or steam.

If, in the desorption of CO₂, water is also removed from the absorption medium, water may be added as necessary to the absorption medium before reuse for absorption.

All apparatuses known from the prior art for desorbing a gas from a liquid can be used for the desorption. The desorption is preferably carried out in a desorption column. As an alternative, the desorption of CO₂ can also be carried out in one or more flash evaporation stages.

The desorption is preferably carried out at a temperature in the range from 50 to 200° C. In the case of desorption by increasing the temperature, the desorption of CO₂ is preferably carried out at a temperature of the absorption medium in the range from 50 to 180° C., particularly preferably from 80 to 150° C. The temperature in the desorption is then preferably at least 20° C. above, particularly preferably at least 30° C. above, the temperature in the absorption. In the case of desorption by increasing the temperature, stripping by means of steam generated by vaporizing a part of the absorption medium is preferably carried out.

In the case of desorption by reducing the pressure, the desorption is preferably carried out at a pressure in the range from 0.01 to 10 bar.

Since the absorption medium used in the method of the invention has a high absorption capacity for CO₂ and is present as a homogeneous single-phase solution in the method of the invention, the method of the invention can be used in plants having a simple construction and achieves improved absorption performance for CO₂ compared to the amines known from the prior art. At the same time, compared to ethanolamine, substantially less energy is required for the desorption of CO₂.

In a preferred embodiment of the method of the invention, desorption is effected by stripping with an inert gas, preferably steam, in a desorption column. The stripping in the desorption column is preferably carried out at a temperature of the absorption medium in the range from 90 to 130° C. The stripping provides a lower residual content of CO₂ in the absorption medium after desorption with a low energy consumption.

The following examples illustrate the invention without, however, restricting the subject matter of the invention.

### EXAMPLES

### Example 1

Preparation of N3-ethyl-N1,N1-dimethyl-1,3-propanediamine

185 g (2.10 mol) of 50% by weight acetaldehyde in methanol were placed in an autoclave and 4.80 g (2.00 mmol) of palladium, 10% by weight on activated carbon (moist with water), 100 ml of methanol and 206 g (2.00 mol) of N1,N1-dimethyl-1,3-propanediamine were added. The autoclave was closed and the mixture was hydrogenated for 5 hours at from 40 to 100° C. and a hydrogen pressure of from 20 to 40 bar. The catalyst was subsequently filtered off and the reaction mixture was fractionally distilled. This gave 71.3 g (0.548 mol, 27.3%) of N3-ethyl-N1,N1-dimethyl-1,3-propanediamine as colourless liquid.

### Example 2

Preparation of N1,N1,N3-trimethyl-1,3-butanediamine

180 g (1.50 mol) of N,N-dimethyl-4-amino-2-butanone and 50 g of ethanol were placed in an autoclave and 3.60 g (1.50 mmol) of palladium, 10% by weight on activated carbon (moist with water), 40 g of ethanol and 148 g (1.57 mol) of 33% by weight methylamine in ethanol were added. The autoclave was closed and the mixture was hydrogenated for 9 hours at 40° C. and a hydrogen pressure of from 20 to 40 bar. The catalyst was subsequently filtered off and the reaction mixture was fractionally distilled. This gave 56.5 g (0.433 mol, 28.9%) of N1,N1,N3-trimethyl-1,3-butanediamine as colourless liquid.

### Example 3

Preparation of N1,N1-dimethyl-N3-propyl-1,3-propanediamine

130 g (2.20 mol) of propionaldehyde and 40 ml of methanol were placed in an autoclave and 4.80 g (2.00 mmol) of palladium, 10% by weight on activated carbon (moist with water), 50 ml of methanol and 206 g (2.00 mol) of N1,N1-dimethyl-1,3-propanediamine were added. The autoclave was closed and the mixture was hydrogenated for 6 hours at from 40 to 120° C. and a hydrogen pressure of from 20 to 40 bar. The catalyst was subsequently filtered off and the reaction mixture was fractionally distilled. This gave 108 g (0.749 mol, 37.5%) of N1,N1-dimethyl-N3-propyl-1, 3-propanediamine as colourless liquid.

### Example 4

Preparation of N1,N1-dimethyl-N3-(1-methylethyl)-1,3-propanediamine

139 g (2.40 mol) of acetone were placed in an autoclave and 4.80 g (2.00 mmol) of palladium, 10% by weight on activated carbon (moist with water), 90 ml of methanol and 206 g (2.00 mol) of N1,N1-dimethyl-1,3-propanediamine were added. The autoclave was closed and the mixture was hydrogenated for 6 hours at from 40 to 120° C. and a hydrogen pressure of from 20 to 40 bar. The catalyst was subsequently filtered off and the reaction mixture was fractionally distilled. This gave 222 g (1.54 mol, 76.8%) of N1,N1-dimethyl-N3-(1-methylethyl)-1,3-propanediamine as colourless liquid.

### Examples 5 to 17

Determination of the absorption capacity for CO₂ and the phase separation temperature

To determine the CO₂ loading and the CO₂ uptake, 150 g of absorption medium composed of 30% by weight of amine and 70% by weight of water were placed in a thermostatable vessel having a top-mounted reflux condenser cooled to 3° C. After heating to 40° C. or 100° C., a gas mixture of 14% by volume of CO₂, 80% by volume of nitrogen and 6% by volume of oxygen was passed at a flow rate of 59 1/h through the absorption medium via a frit at the bottom of the vessel and the CO₂ concentration in the gas stream exiting the reflux condenser was determined by IR absorption using a CO₂ analyser. The difference between the CO₂ content in the gas stream introduced and in the exiting gas stream was integrated to give the amount of CO₂ absorbed, and the equilibrium CO₂ loading of the absorption medium was calculated. The CO₂ uptake was calculated as the difference in the amount of CO₂ absorbed at 40° C. and at 100° C. The equilibrium loadings at 40 and 100° C. in mol of CO₂/mol of amine and the CO₂ uptake in mol of CO₂/kg of absorption medium are shown in Table 1.

To determine the phase separation temperature, CO₂-free absorption medium composed of 30% by weight of amine and 70% by weight of water was heated stepwise in steps of 10° C. each to 90° C. in a closed glass vessel and the temperature at which clouding or separation into two liquid phases was discernible was determined.

Examples 5 to 17 show that a high weight-based capacity of the absorption medium for the absorption of CO₂ is achieved when using amines of formula (I), and phase separation of the absorption medium can be avoided both in absorption and in desorption of CO₂ due to the high phase separation temperature. On the other hand, phase separation of the absorption medium can occur for the amines of examples 8 and 9 known from WO 2011/080405 because of the lower phase separation temperature.

TABLE 1

| | | | | | Phase |
|---|---|---|---|---|---|
| | | Loading at | Loading at | | separation |
| | | 40° C. in | 100° C. in | CO₂ uptake | temperature |
| Example | Amine | mol/mol | mol/mol | in mol/kg | in ° C. |
| 5* | Ethanolamine | 0.57 | 0.22 | 1.72 | |
| 6* | Methyldiethanolamine | 0.38 | 0.05 | 0.82 | |
| 7* | N1,N1-Dimethyl-1,3-propanediamine | 1.13 | 0.69 | 1.30 | >90 |
| 8 | N3-Ethyl-N1,N1-dimethyl-1,3-propanediamine | 1.32 | 0.50 | 1.87 | >90 |
| 9 | N1,N1,N3-Trimethyl-1,3-butanediamine | 1.22 | 0.34 | 2.03 | >90 |
| 10 | N1,N1-Dimethyl-N3-propyl-1,3-propanediamine | 1.33 | 0.53 | 1.66 | >90 |
| 11 | N1,N1-Dimethyl-N3-(1-methylethyl)-1,3-propanediamine | 1.27 | 0.31 | 2.00 | >90 |
| 12* | N3-Butyl-N1,N1-dimethyl-1,3-propanediamine | 1.25 | 0.39 | 1.62 | 70 |
| 13* | N1,N1-Dimethyl-N3-(1-methylpropyl)-1,3-propanediamine | 1.31 | 0.38 | 1.77 | 80 |
| 14* | N1,N1-Dimethyl-N3-propyl-1,3-butanediamine | 1.13 | 0.35 | 1.48 | 70 |
| 15* | N1,N1-Dimethyl-N3-pentyl-1,3-propanediamine | 1.19 | 0.22 | 1.69 | 50 |
| 16* | N1,N1-Diethyl-N3-propyl-1,3-butanediamine | 1.13 | 0.35 | 1.48 | <20 |
| 17* | N1,N1-Dimethyl-N3-heptyl-1,3-propanediamine | 1.51 | 0.18 | 1.99 | <20 |

*not according to the invention

1. A method of absorbing CO₂ from a gas mixture by bringing the gas mixture into contact with an absorption medium, wherein the absorption medium comprises water and at least one amine of formula (I)
R¹R²NCH₂CH₂CHR⁴NHR³, (I)
where R¹, R² and R³ are, independently of one another, C₁-C₃-alkyl radicals, R⁴ is hydrogen, methyl or ethyl and the radicals R¹, R², R³ and R⁴ together comprise not more than 5 carbon atoms.

2. The method according to claim 1, wherein R⁴ in formula (I) is hydrogen.

3. The method according to claim 2, wherein R¹ and R² in formula (I) are each, independently of one another, methyl or ethyl.

4. The method according to claim 3, wherein R¹ and R² in formula (I) are each methyl.

5. The method according to claim 4, wherein R³ in formula (I) is n-propyl or isopropyl.

6. The method according to claim 1, wherein the content of amines of formula (I) in the absorption medium is from 20 to 50% by weight.

7. The method according to claim 1, wherein the gas mixture is a combustion off-gas, a natural gas or a biogas.

8. The method according to claim 1, wherein CO₂ absorbed in the absorption medium is desorbed again by increasing the temperature and/or reducing the pressure and the absorption medium after the desorption of CO₂ is used again for the absorption of CO₂.

9. The method according to claim 8, wherein the absorption is carried out at a temperature in the range from 0 to 80° C. and the desorption is carried out at a higher temperature in the range from 50 to 200° C.

10. The method according to claim 8, wherein the absorption is carried out at a pressure in the range from 0.8 to 50 bar and the desorption is carried out at a lower pressure in the range from 0.01 to 10 bar.
